(19) United States
(12) Patent Application Publication
(10) Pub. No.: US 2020/0112450 A1
(43) Pub. Date: Apr. 9, 2020

(54) SYSTEM AND METHOD FOR AUTOMATICALLY CONNECTING TO A CONFERENCE

(71) Applicant: MICROSOFT TECHNOLOGY LICENSING, LLC, Redmond, WA (US)

(72) Inventors: Shalendra CHHABRA, Seattle, WA (US); Eric Randall SEXAUER, Woodenville, WA (US); Amey PARANDEKAR, Seattle, WA (US)

(73) Assignee: MICROSOFT TECHNOLOGY LICENSING, LLC, Redmond, WA (US)

(21) Appl. No.: 16/153,673

(22) Filed: Oct. 5, 2018

(51) Int. Cl. H04L 12/18

(52) U.S. Cl. CPC H04L 12/1822; H04L 12/1818

(57) ABSTRACT

A method and system for automatically joining a conference is disclosed, in which a user is offered an option for enabling the automatic connection to the conference at multiple instances prior to the scheduled meeting. The user can specify the time the connection should occur, and specify which conference events they would like to be automatically connected to. An auto-record feature can also be made available to permit users to specify conferences that should be recorded. A ‘snooze’ option can also be presented to the user to have the system reattempt the automatic connection at a later time.

### BACKGROUND

There are a number of conference tools presently available for enabling people to conduct live meetings, conferences, presentations, or other types of gatherings via the Internet, the public switched telephone network (PSTN), or other voice and/or data networks. In these cases, participants typically use a telephone, computer, or other communication device that connects to a conference system or server. The meetings include an audio component and/or a visual component, such as, a shared presentation, video, whiteboard, or other multimedia, text, graphics, etc. These types of convenient conference solutions have become an indispensable form of communication for many businesses and individuals.

Typically, such conference calls involve an organizer initially scheduling a conference call and sending invitations to the desired participants. Each invited participant can be provided a subject of the conference, a call-in telephone number, a time and date for the conference call, an access code in the form of a pass code and, perhaps, a list of other participants. An invited participant is then required to call the call-in number at the particular time and date, enter a pass code and subsequently be connected to the scheduled conference call.

Conference calling enables multiple parties to conveniently meet and conduct business without the expense, both time and money, incurred by traveling to a particular location. However, while existing conference, meeting, grouping or other types of gathering systems offer many advantages, there remain significant areas for new and improved ideas for allowing users with to easily and efficiently identify their conference session preferences in conjunction with their day to day calendar.

### SUMMARY

A system, in accord with a first aspect of this disclosure, includes at least one processor and one or more computer readable media. The computer readable media include instructions which, when executed by the at least one processor, cause the at least one processor to cause to be displayed, to a first user for a first conference event, a first user interface including a first selectable option for the first user to be automatically connected to the first conference event. The instructions also cause the at least one processor to record, in response to a first user selection of the first selectable option, a first authorization to automatically connect the first user to the first conference event. The instructions further cause the at least one processor to automatically initiate, in response to the recorded first authorization and at a time associated with the first conference event, a first telecommunications session with the first user, thereby connecting the first user to the first conference event.

A method, in accord with a second aspect of this disclosure, includes receiving a conference organization request identifying time of a first conference event and a plurality of attendees including a first attendee. The method further includes delivering, to a first device associated with the first attendee identified in the conference organization request, a meeting invite with embedded control signals that, when executed by the first device, cause the first device to display a first user interface including the time of the first conference event, a first selectable option indicating accepting or declining the meeting invite, and a second selectable option indicating whether to automatically establish connection between a system hosting the first conference event and one or more devices associated with the first attendee. In addition, the method includes receiving, from the first device, a first response to the displayed first user interface, the first response including a user selection of the first selectable option accepting the meeting invite, and a user selection of the second selectable option to automatically establish a connection between the system hosting the first conference event and the one or more devices associated with the first attendee. Furthermore, the method includes setting a connection trigger condition corresponding to the first attendee and the first conference event, the connection trigger condition specifying a trigger time, set based on the time of the first conference event, to automatically establish a connection between the system hosting the first conference event and the one or more devices associated with the first attendee. The method also involves determining that the connection trigger condition has been met, automatically causing a first connection to be established between the system hosting the first conference event and a second device of the one or more devices associated with the first attendee, and causing the first attendee to be admitted into the first conference event.

A system, in accord with a third aspect of this disclosure, includes means for receiving a conference organization request identifying time of a first conference event and a plurality of attendees including a first attendee, and means for delivering, to a first device associated with the first attendee identified in the conference organization request, a meeting invite with embedded control signals that, when executed by the first device, cause the first device to display a first user interface means including the time of the first conference event, a first selectable option indicating accepting or declining the meeting invite, and a second selectable option indicating whether to automatically establish connection between a means for hosting the first conference event and one or more devices associated with the first attendee. The system further includes means for receiving, from the first device, a first response to the displayed first user interface means, the first response including a user selection of the first selectable option accepting the meeting invite, and a user selection of the second selectable option to automatically establish a connection between the means for hosting the first conference event and the one or more devices associated with the first attendee. In addition, the system includes means for setting a connection trigger condition corresponding to the first attendee and the first conference event, the connection trigger condition specifying a trigger time, set based on the time of the first conference event, to automatically establish a connection between the means for hosting the first conference event and the one or more devices associated with the first attendee. Furthermore, the system includes means for automatically causing, in response to determining that the connection trigger condition has been met, a first connection to be established between the means for hosting the first conference event and a second device of the one or more devices associated with the first attendee and means for causing the first attendee to be admitted into the first conference event.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1 and 2 each illustrate an implementation of a group of participants in a conference call and a potential configuration for each participant's connection to the conference call;

FIGS. 3 and 4 are display diagrams illustrating an implementation of a user interface for an application configured to provide options for joining a conference call during creation of a meeting invitation;

FIG. 5 is a display diagram illustrating an implementation of a user interface for an application configured to provide options for joining a conference call upon receipt of a meeting invitation;

FIG. 6 is a display diagrams illustrating an implementation of a user interface for an application configured to provide options for joining a conference call during review of a calendar;

FIGS. 7A and 7B are display diagrams illustrating an implementation of a reminder notification interface for an application configured to provide options for joining a conference call;

FIG. 8 is a display diagram illustrating an implementation of a user interface for an application configured to permit a user to identify various preferences for joining a conference call;

FIGS. 9A and 9B are a process flow diagram of an implementation for establishing a connection to a conference call;

FIG. 10 is a flow diagram illustrating an implementation of a process for joining a conference call;

FIG. 11 is a block diagram of an example computing device, which may be used to provide implementations of the mechanisms described herein; and

FIG. 12 is a block diagram illustrating components of an example machine configured to read instructions from a machine-readable medium.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following implementations introduce a method and system for automatically joining a scheduled conference event, where a user may be offered options for enabling the automatic connection to the conference at various stages or instances prior to the scheduled meeting. Traditionally, conference scheduling has included a series of steps where users can: (1) schedule a meeting; (2) generate an invitation to send to participant(s); (3) receive an invitation; (4) RSVP for the meeting; (5) connect to the meeting; and (6) communicate with fellow participants and/or present audio or video in real-time, during the conference.

However, there are many technical problems associated with this process. For example, participants can fail to recall they have an upcoming meeting, incorrectly recall the time or date the meeting has been scheduled, or they may be away from a device that would facilitate their access to the meeting. In some other cases, a user may set an alarm on a personal device to remind them of the conference, but at the time of the alarm they may be away from the device generating the alarm, have inadvertently muted the alarm, or be unable to recall which event the alarm was associated with. In addition, if the meeting has been rescheduled to a different time, the alarm may not be updated, and result in that user missing the meeting. Even in cases where the user remembers the scheduled meeting in a timely manner, they may encounter situations where they are away from the office or from the device that would facilitate their access to any conference login information, thereby delay their attempts to join the call. If the user is in a location where there is no internet, they may be unable to enter the correct access code and number.

As will be discussed below, the disclosed implementations offer a powerful set of technical solutions by which a user can ensure a timely and ready automatic connection to meetings at particular instances leading up to the meeting. The option will be provided to the user in a manner that maximizes convenience and efficiency. For example, the option to be automatically connected to a meeting can be presented to a user as he or she is scheduling the meeting, during their review of the invitation or while RSVP-ing, and/or while viewing reminders, calendar updates or previews, or other items associated with meeting preparation, information, or notifications. By offering users the option to auto-join a conference during one or more workflow instances leading up to the meeting, a user can make better decisions for their day-to-day schedule, as well as easily modify their connection preferences for each meeting that appears on their calendar.

These solutions provide a wide array of advantageous technical effects. By opting to auto join a meeting, a user can be contacted directly at a preferred device(s) and/or via a preferred application(s), without being prompted to enter access codes, pin numbers, website passwords, or other such login credentials, and participate in the conference event with little effort. Furthermore, by providing individual event opportunities to select the auto join feature, a user can customize the manner in which they connect to each particular meeting on their calendar, per their preference, at first view—as they receive invitations or as they create an invitation. For example, a user may auto-connect to some meetings, and manually connect to other meetings. In addition, the auto-connect settings or configuration may be adjusted for each conference event that occurs. As will be discussed below, users can also opt to auto-record upcoming meetings (or meetings in progress), providing the benefit of access to meeting history and information, as well as the added advantage of ‘attending’ meetings that overlap in time by subsequent playback of the missed portions or conferences.

For purposes of this application, a conference event (“conference”) or a meeting can refer to a real time, or near-real time, telecommunication session involving two or more participants. Thus, a meeting can encompass an event, activity, gathering, assembly, class, conference, convention, summit, get-together, congregation, reunion, or the like that may be prescheduled. Examples can include a conference call, a World Wide Web (Web) based conference, a videoconference, and/or a multi-party instant messaging (IM) or chat session. As will be discussed below, when a scheduled conference arises, the participants who have opted to be automatically joined to said conference will be contacted and then joined into the conference, and/or can receive a notification via a selected communication channel that provides a link to access the meeting.

In addition, the term scheduled meeting or scheduled conference as used throughout this application refers to a communication session that has been scheduled for a particular date/time. It should be understood that the disclosed implementations may also be applicable to meetings that have not yet been scheduled. For example, as a user is creating the meeting, or if a general meeting notice is communicated and the time/date is to be announced or determined at a later time (TBA/TBD), or before a meeting has been finalized.

Furthermore, while the terms “call” or “calls” will be used in the description, the described systems and methods are also applicable to session-based telecommunications in general and are not limited to voice calls. It will also be appreciated that the systems and methods are not limited to sessions and are applicable to messaging-based or packet-based communications. Thus, conference calls can include exchange of as any combination of voice data, video data, text data, image data (e.g., presentation data), file data, or any other types of data.

As noted above, the option to automatically connect to a scheduled meeting or conference event can be configured to occur at various workflow instances of a meeting lifecycle and can have an effect on both the connection process as well as aspects of the meeting itself. A meeting lifecycle includes the time during the meeting, as well as the time prior to the meeting and the time after the meeting. The workflow instances for a meeting therefore include any step, event, action, or communication associated with the meeting, and can include but is not limited to creation of the meeting, receipt of a meeting invite, communications between invitees of the meeting, meeting documents shared with invitees, agenda or calendar notifications related to the meeting, meeting updates, and so forth. Furthermore, the following implementations may refer to the concept of “first view”, which refers to an instance in which a participant first engages with information for the meeting; for example, while creating the meeting or when receiving the invite.

For purposes of this application, usage of the terms “automatically connect”, “automatically join”, “auto-connect”, or “auto-join” refer to the capability of a system to automatically initiate and establish a connection between a system hosting the conference event and one or more devices associated with the attendee when a predetermined date and time occurs and/or specified conditions are met. For example, if the auto-connect feature is enabled, the system can be configured to begin placing outgoing telephone calls via a telephony system to a participant that has opted to be auto-connected to the meeting. As another example, the system may be configured to generate and/or transmit notifications on the date and around the time of the conference via a direct link the meeting to participants that have authorized auto-connect functionality.

Furthermore, references to a communication application, a scheduling application, an organizer application, or simply “application” may be understood to refer to any software applications configured to provide a means of scheduling, viewing, modifying, joining a meeting, and/or communicating or transmitting or receiving data associated with the meeting. This can include any type of electronic calendar or electronic scheduling system that is capable of tracking a user's meetings or appointments. Some such programs can include Skype®, Microsoft Teams®, Microsoft Outlook®, GoToMeeting®, WebEx®, Zoom®, Join.Me®, GoogleHangouts®, AnyMeeting® and other applications that can provide conferencing tools and/or facilitate communication or collaboration online. These are non-limiting examples, and any other communication-related application may benefit from the disclosed implementations. Specific references to a software application by name throughout this description should not therefore be understood to limit the use of the proposed systems and methods. It should further be understood that in some implementations, the application used to enable an auto-connection function may differ from the application used to schedule the meeting, while in other implementations, they may be the same.

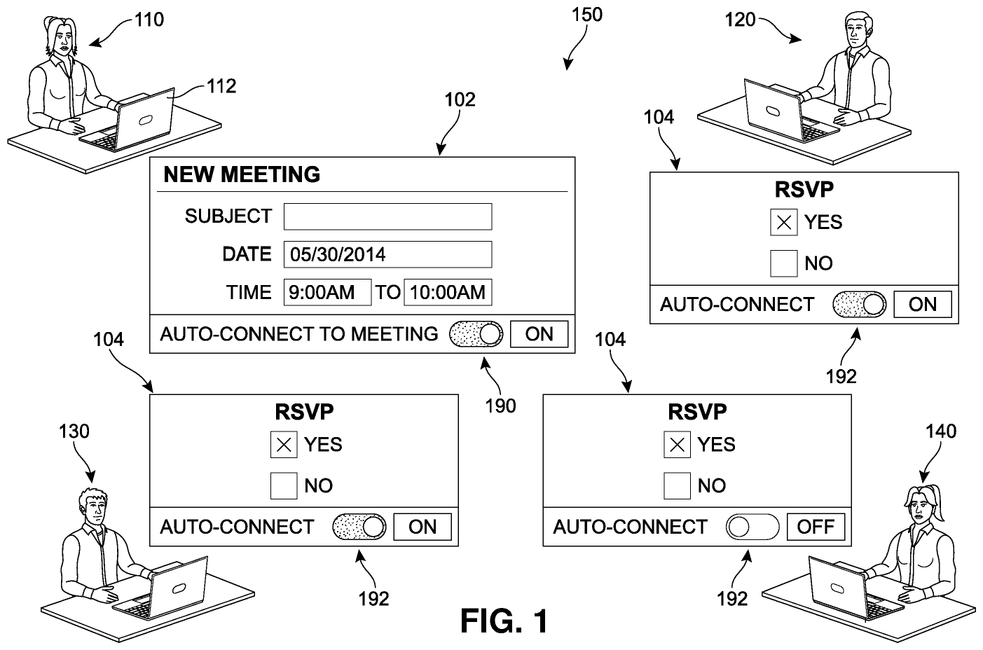

In order to better introduce the technical solutions offered by the disclosed systems and methods, FIG. 1 presents a high-level example of a representative conference environment (“environment”) 150 for implementing a conference management system. In different implementations, the environment 150 can include one or more computing device end-users, or simply “users”. As an example, a first user 110, a second user 120, a third user 130, and a fourth user 140 are shown in FIG. 1. In this case, the first user 110 is accessing a meeting scheduler user interface on a first device 112. It can be understood that the first device 112 is configured for connection to a network. As first user 110 initially schedules and creates the meeting via a meeting scheduling interface 102, the first user 110 may be understood to have been provided their ‘first view’ of any details associated with the conference. Similarly, once the invitation has been completed and invites 104 sent to various persons (here represented by second user 120, third user 130, and fourth user 140), these persons will have been provided with their ‘first view’ of the meeting information, as they open the invitation.

In this example, the first user 110 is presented with an initial selectable option 190 to auto join a meeting they are currently creating and the second user 120, third user 130, and fourth user 140 are also presented with their own selectable options 192 as they view their respective invitations to the meeting. In other words, during their first viewing of information (“first instance”) associated with the conference, each potential attendee is able to easily select if they prefer to be auto joined to the meeting. By displaying this option during the first viewing of the meeting information, when a user is most likely to give their most attention and time to the details of the conference, a user can create and/or respond to an invite, consider the logistics of the meeting, and make a measured, thoughtful choice as to whether they prefer to be auto joined this particular event.

As shown in FIG. 1, all three invitees have responded affirmatively to the meeting invite (“YES”). Furthermore, each of the first user 110 (the meeting organizer), and the second user 120 and third user 130 have enabled auto-join mode, while the fourth user 140 has declined to authorize auto-joining the meeting.

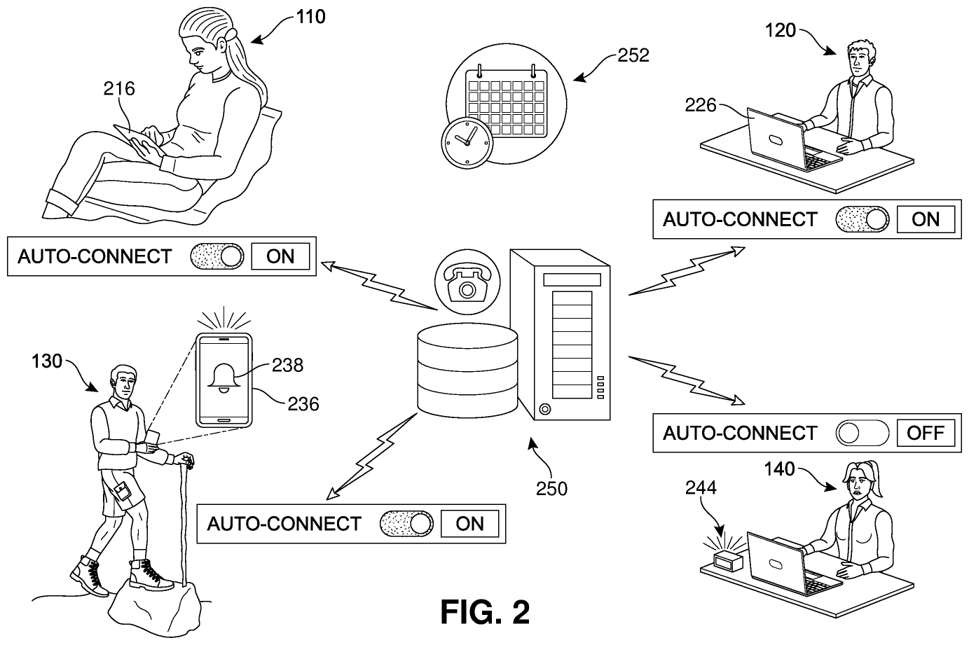

Referring now to FIG. 2, one possible technical effect of the previous connection mode selections by each user is depicted. In FIG. 2, a conference management system (“system”) 250 has automatically initiated a connection to the meeting to each of the first user 110, second user 120, and third user 130 at a time 252 associated with the conference event. The fourth user 140 has joined the meeting by manual connection. FIG. 2 exemplifies some of the advantages provided to users as a result of their auto-connect authorization. In this example, the first user 110 is able to join the meeting while seated outside—away from their desk—via an automatic connection provided by the system 250 via a local application on their tablet device 216. The second user 120 is able to join the meeting from their office computer 226 via online conference software. Neither the first user 110 nor the second user 120 are requested to provide login credentials prior to connecting, nor are they required to remember any details regarding the meeting start time. The third user 130 is also away from their desk, and has received a telephone call on their mobile device 236. In this case, the third user 130, in a remote location, receives the call, and opts to ‘snooze’ 238 the proffered connection to a later time (e.g., attempt to connect the user again in 2 minutes, 5 minutes, 10 minutes, etc.). Finally, the fourth user 140 had relied on an alarm 244 and then reviewed the conference details in order to manual joined the meeting by entering the necessary connection credentials.

It can be seen that the benefits this type of technical solution, whereby one is given the option to auto join the conference while initially viewing information for the conference, itself can significantly simplify the connection process for each invitee. The user is no longer required to expend time or attention in following additional steps to be connected to the call, nor are they required to modify their overall connection preferences (applicable to all conferences), for example via a generalized or indiscriminate settings menu in order to facilitate their connection to one particular meeting. As will be discussed below, the option to auto join can be provided during one or all instances in which information associated with each individual conference is communicated to a user, without affecting a user's connection preferences for other meetings.

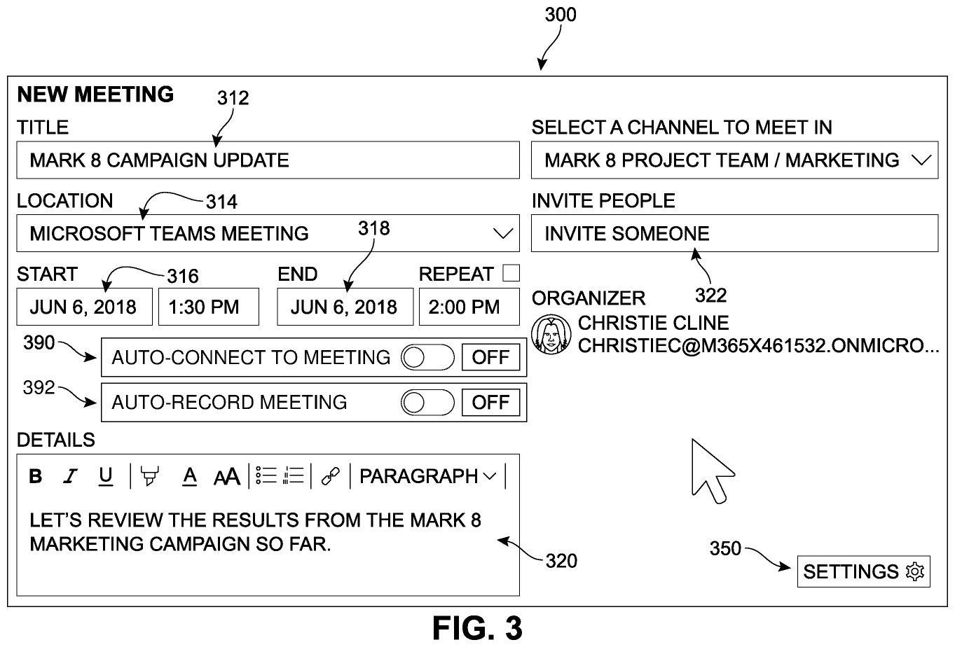

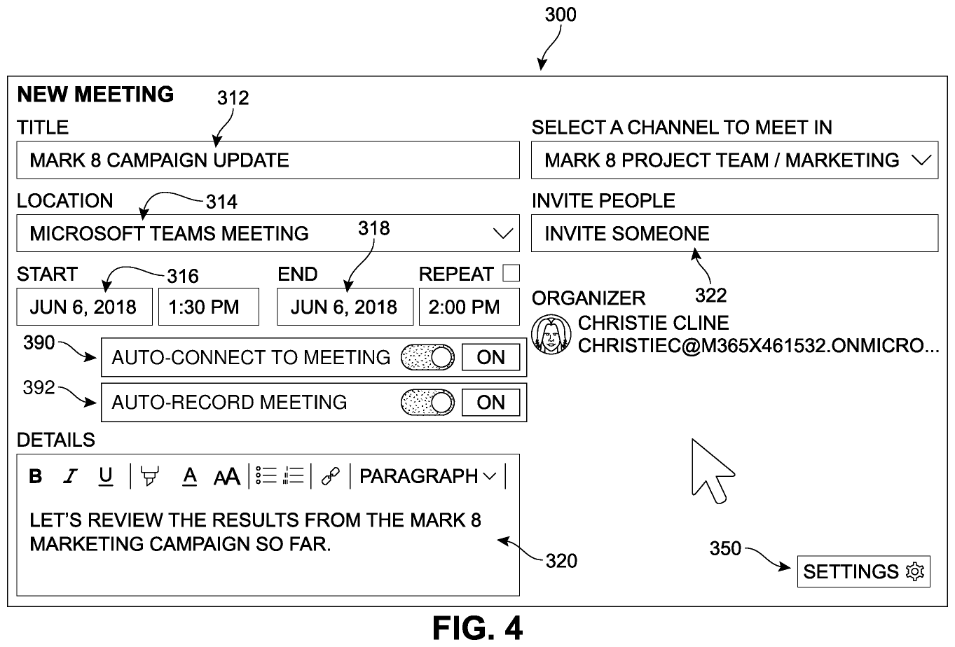

Referring now to FIGS. 3-4, one example of the proposed technical implementations is presented. In FIG. 3, a new meeting is being scheduled via a native control, here illustrated as a scheduler user interface 300 of a scheduling application (“application”). For purposes of this description, a “native control” refers to a mechanism for communicating content through a client application to an application user. For example, native controls may include pop-up windows that may be presented to a user as software application user interfaces (UIs), interactive buttons, or other objects that may be shown to a user through native application UIs, as well as mechanisms that are native to a particular application for presenting associated content with those native controls. In different implementations, a native control can include any other type of user interface such as a dialog box, notification, alert, reminder, email, instant message, or other application communication or presentation means. In addition, a “trigger event” or “triggering event” refers to an event (or specific sequence of events) associated with a particular use of an application, which corresponds to a selection of an option offered via a native control, or an event that matches a condition. In FIG. 3, the triggering event may be understood to include a ‘click’, toggle, or other input actions (such as a mouse left-button or right-button click, a touchscreen tap, a selection of data, or other input types).

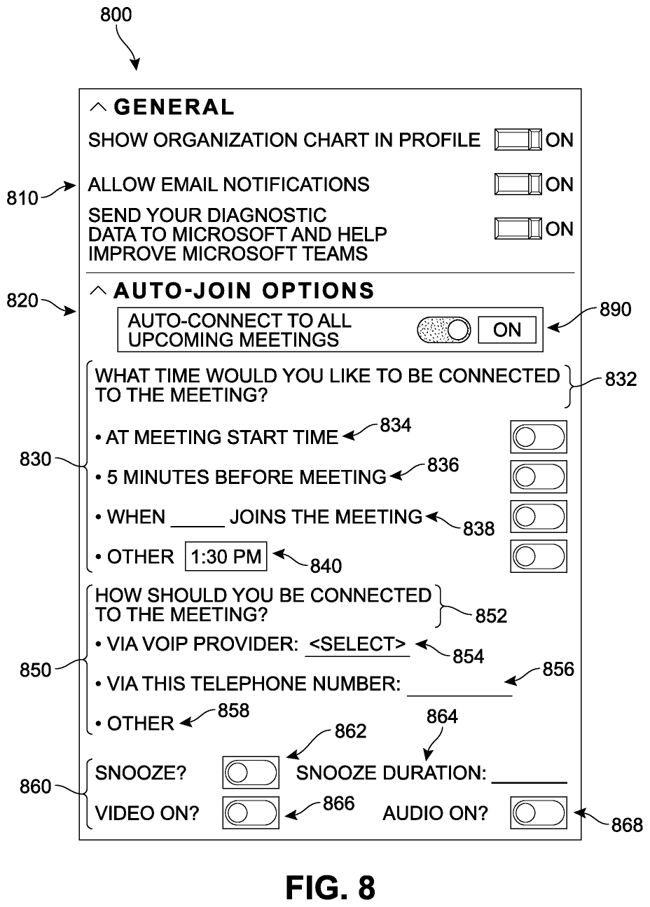

The scheduler user interface 300 includes a plurality of fields 310 for receiving meeting-related input, including but not limited to a title field 312, a location field 314, a start field 316, an end field 318, a meeting details field 320, and an invitees field 322. In different implementations, the application can be configured to present additional or other options to a user. As one example, a selectable option 390 is included by which a user may request to be auto-joined to this meeting. In FIG. 3, the selectable option 390 is in an inactive or “OFF” mode. However, following a user triggering event in FIG. 4, the selectable option 390 is shown in an active or “ON” mode, indicating that the user has opted to be auto joined to this meeting. It should be understood that while in some cases the default setting is that auto-join is disabled, in other implementations, the default or initial setting may be that the auto-join function is enabled or ON. In different implementations, a user may wish to customize the manner or process by which they are auto-joined, as illustrated by (optional) settings option 350, and which will be discussed further below with respect to FIG. 8. It should be understood that a Settings option may be made available on each of the user interfaces described herein, whether or not explicitly identified.

While the selectable option 390 is positioned beneath the end field 318 and meeting details field 320 in FIGS. 3 and 4, it should be understood that in other implementations, the option may appear differently and/or may be displayed or generated anywhere else on the screen(s) associated with the client's system, including spaced apart from, adjacent to, or around the scheduler user interface 300.

Another technical conferencing management solution is shown in FIG. 3. In some implementations, a selectable auto-record option 392 is included by which a conference organizer or creator may request to have this meeting automatically recorded. They may choose to configure the type of recording (e.g., audio, video, audio and video, chat messages, and/or deck slides) and where the recording should be stored for later access. In addition, the auto-record feature can be implemented across multiple meetings occurring over the same interval of time, giving users a chance to readily manage conflicting schedules and overlapping information. A user can also opt to both auto-record and auto join a meeting in one implementation. In FIG. 3, the auto-record option 392 is in an inactive or “OFF” mode. However, following a user triggering event in FIG. 4, the auto-record option 392 is shown in an active or “ON” mode, indicating that the user has opted to be auto joined to this meeting. In different implementations, a user may wish to customize the manner or process by which the auto-recording occurs, as illustrated by (optional) settings option 350.

In different implementations, a conference organization request can also be sent to an invitee with details for a scheduled meeting (meeting invitation). This invitation can identify time of a first conference event and a plurality of attendees including a first attendee. For example, a remote system can be configured to deliver to a web browser application executing on the user's device as identified in the conference organization request a meeting invite. This meeting invite can include embedded control signals that, when executed by the user's device, cause the device to display a first user interface. In different implementations, the first user interface can include the time of the first conference event, a first selectable option indicating accepting or declining the meeting invite, and/or a second selectable option indicating whether to automatically establish connection between a system hosting the first conference event and one or more devices associated with the first attendee.

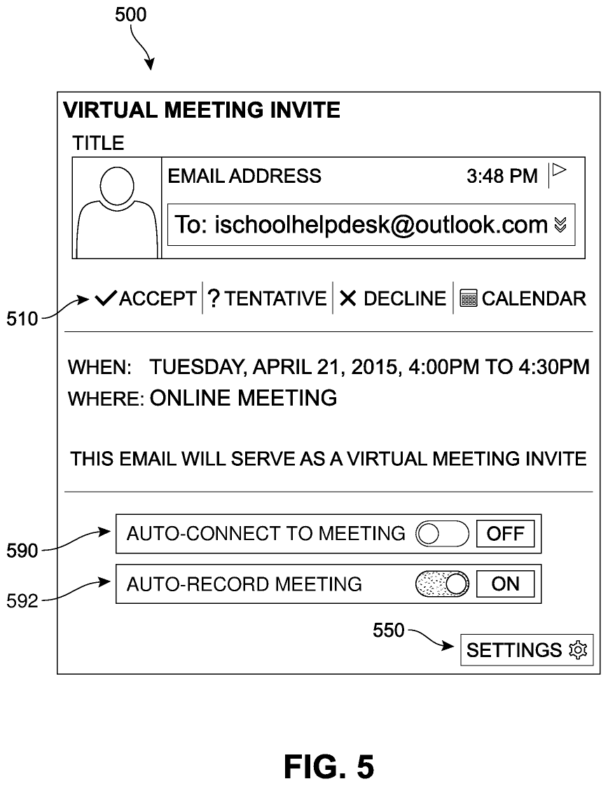

For purposes of clarity, one example of a meeting invitation is depicted in FIG. 5 where a user is presented with information for an upcoming meeting via an invitation user interface 500. The invitation user interface 500 specifies the various logistical details for the meeting, including when it is scheduled, where it will be held, and other such information. The invitation user interface 500 further includes an RSVP section 510 with various selectable options, which can be selected by a user to facilitate the submission of a response by the user for the meeting. This depiction may be understood to represent a user's first view or “first instance” of the meeting information, or may represent subsequent views of the invitation, a reminder invitation generated by the system, or other types of meeting-related information instances.

A selectable option 590 is included by which a user may request to be auto-joined to this meeting. In FIG. 5, the selectable option 590 is in an active or “ON” mode as a result of a user's selection of the option. It should be understood that a user may also deactivate the option by switching the selectable option 590 back to the OFF position. In different implementations, a user may wish to customize the manner or process by which they are auto-joined, as illustrated by (optional) settings option 550, and which will be discussed further below with respect to FIG. 8. It should be understood that a Settings option may be made available on each of the user interfaces described herein, whether or not explicitly identified.

Thus, in different implementations, the remote system can be configured to receive, from the user's device, a response to the displayed first user interface. The response can include a user selection of the first selectable option accepting the meeting invite, and a user selection of the second selectable option to automatically establish a connection between the system hosting the conference event and one or more devices associated with the user. This can command the remote system to set a connection trigger condition corresponding to the user and the conference event. The connection trigger condition can specify a trigger time, set based on the time of the conference event, to automatically establish a connection between the system hosting the conference event and the one or more devices associated with the user. Once the remote system determines that the connection trigger condition has been met, it can automatically cause a connection to be established between the system hosting the conference event and the same or other device associated with the user, causing the user to be admitted into the first conference event.

Furthermore, as described above with respect to FIGS. 3 and 4, in some implementations, a selectable auto-record option 592 can also be included in the conference invitation (or other conference communications), by which a user may request to have this meeting automatically recorded. They may choose to configure the type of recording (e.g., audio, video, audio and video, chat messages, and/or deck slides) and where the recording should be stored for later access. In addition, the auto-record feature can be implemented across multiple meetings occurring over the same interval of time, giving users a chance to readily manage conflicting schedules and overlapping information. A user can also opt to both auto-record and auto-join a meeting in one implementation. In FIG. 5, the auto-record option 592 is in an active or “ON” mode, indicating that the user has opted to be auto joined to this meeting. In other words, while they will not be auto joining the meeting, they nevertheless wish to automatically record and store the meeting event for later use. In different implementations, a user may customize the manner or process by which the auto-recording occurs, via settings option 550.

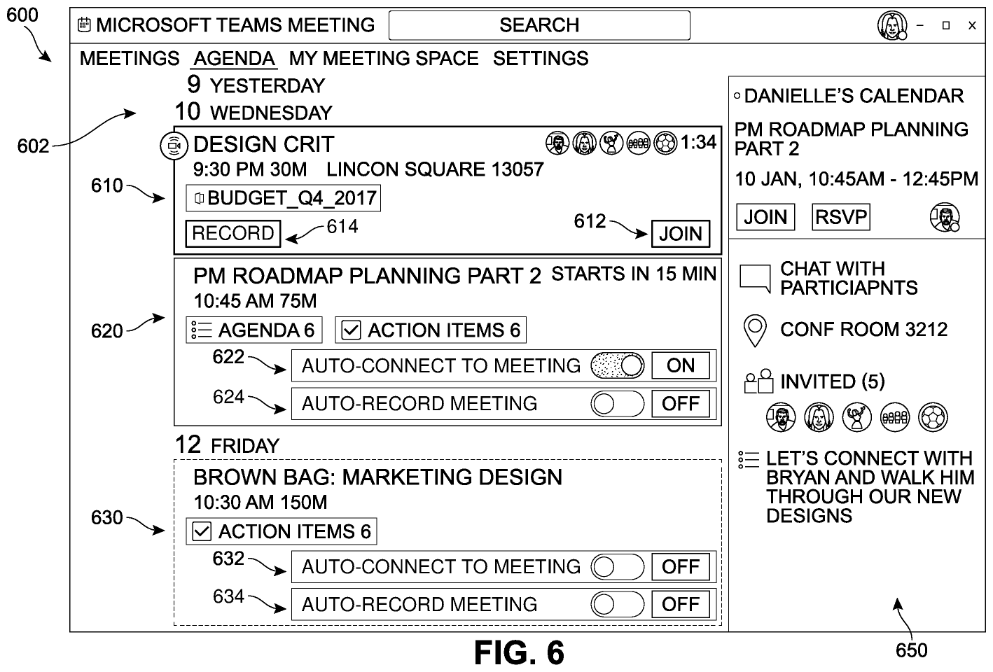

In different implementations, a user may continue to receive information for various meetings and events on a collaboration, calendar, or agenda component of a conferencing application. Referring to FIG. 6, an example of an agenda component 600 is shown. The agenda component 600 includes a calendar panel 602 that can be configured to present the various events or activities of interest to a user over a specified duration. In some implementations, there may also be a detailed view panel 650 that can provide a space for additional information for an event to be displayed, or to provide various options for any of the meetings. This type of meeting management tool can include one or more of the technical solutions described herein.

The calendar panel 602 in this example includes a first indicator 610 for a first meeting, a second indicator 620 for a second meeting, and a third indicator 630 for a third meeting. Each indicator can be configured to display or present information specific to one event or activity. In FIG. 6, the indicators include the title of the event, as well as its scheduled time, and its expected duration. In some cases, there may be meeting materials that have been made available that can be viewed by selecting the listed attachment link.

With respect to the first indicator 610, it can be seen that the first meeting (“Design Crit”) is already in progress, and an auto join option is not offered—instead a first selectable option 612 indicates only a straightforward “Join” function that may remain available throughout the duration of an ongoing meeting. In addition, a user can opt to initiate a recording of the in-progress meeting from their calendar (see a selectable record option 614), without necessarily joining the meeting or having to access further interfaces or settings.

A later meeting is represented by the second indicator 620 (“PM Roadmap Planning Part 2”) that has an upcoming start time. For purposes of illustration, the second indicator 620 can be understood to represent a second instance or second viewing of information for a specific meeting that has been presented to a user. In this case, the user is being shown various details for the second meeting via the second indicator 620, including their previously submitted preference to be auto-joined to this meeting, as reflected by a second selectable option 622 being switched “ON”. It should be understood that they can review and modify their previous selection to Auto-Join the meeting via the second selectable option 622 via the second indicator 620 (e.g., turn the option to “OFF” via the second selectable option 622). Furthermore, a first selectable auto-record option 624 is also shown, by which a user can request the system to automatically record the conference, as discussed herein.

In addition, the third indicator 630 is directed to a third meeting (“Brown Bag: Marketing Design”) occurring on a later date. This indicator can similarly be understood to represent a second instance or second viewing by the user of information for a specific meeting. In this case, the user is shown various details for the second meeting, including their preference to not be auto joined to this meeting, as reflected by a third selectable option 632 being switched “OFF”. As noted above, they can review and modify their selection to Auto-Join the meeting via the third selectable option 632 (e.g., turn the option to “ON” via the third selectable option 632). A second selectable auto-record option 634 is also shown, by which a user can request the system to automatically record the conference.

Thus, it can be seen that across different implementations, meeting information may be conveyed in many other formats and over a plurality of instances. As a few non-limiting examples, reminders or other types of notifications for a particular meeting may be sent to a user, updates to the meeting may occur and require the meeting information to be re-sent, meeting-related pop-up windows or ‘toasts’ can appear on user devices, chat messages related to the meeting may be communicated between participants, emails discussing the upcoming meeting may be sent, or SMS messages with meeting information can be generated.

Each instance can include information that provides a user with details or a message associated with a specific or particular conference event. Thus, a user may receive one, two, three, or multiple instances over the course of the pre-meeting workflow, where each instance that occurs is in some way related to the upcoming scheduled meeting. These notifications or indicators can also occur once the scheduled meeting has begun, for example, via a reminder email to the user that has failed to connect to the meeting on time.

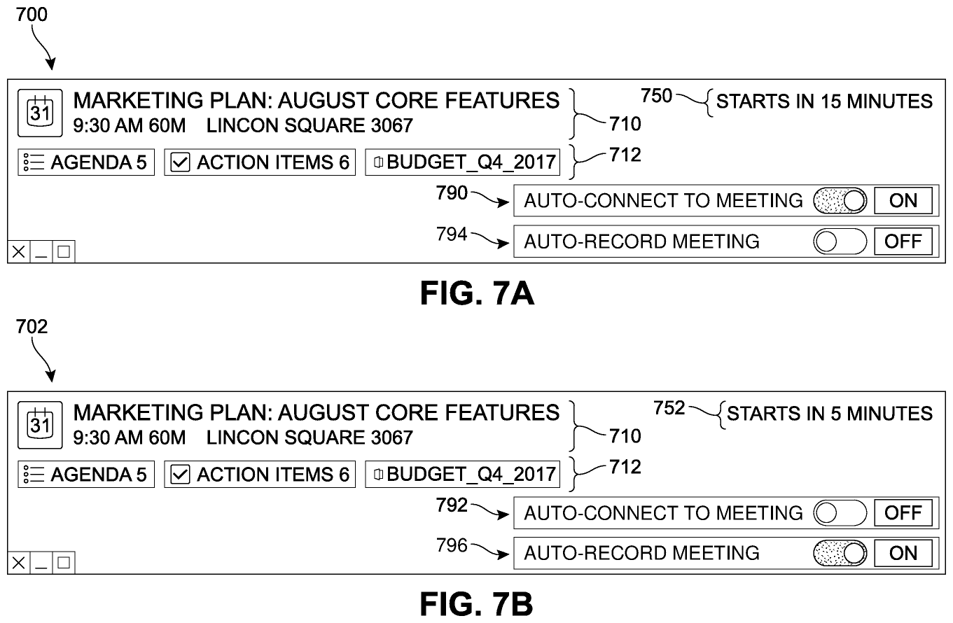

In different implementations, the technical solution(s) offered by the auto-join feature and/or auto-record feature are configured to be presented as a recurring or repeated option, during any one of the pre-meeting instances in which any information associated with a specific meeting is communicated or conveyed to a user. A further example of this mechanism is shown in FIG. 7A, where an example of a first reminder for a third meeting 710 is presented via a first notification interface 700. The first notification interface 700 includes information associated with the third meeting 710, including meeting logistics and materials (meeting information 712). In addition, the first notification interface 700 alerts the user with a first sub-message 750 how much time is remaining until the meeting is scheduled to begin (“Starts in 15 minutes”).

The first notification interface 700 can be understood to represent an additional instance (e.g., second instance) of information for the third meeting 710 being presented to a user. In this case, the user is shown various details for the third meeting, including their preference to be auto joined to this meeting, as reflected by a fourth selectable option 790 being switched “ON”.

In FIG. 7B, an example of a second reminder for the third meeting 710 is presented via a second notification interface 702. The second notification interface 702 similarly includes information associated with the third meeting 710, including meeting logistics and materials (meeting information 712). In addition, the second notification interface 702 alerts the user with a second sub-message 752 how much time is remaining until the meeting is scheduled to begin (“Starts in 5 minutes”). The second notification interface 702 can be understood to represent an additional (e.g., third instance) of information for the third meeting 710 being presented to a user. In this case, the user has decided to toggle a fifth selectable option 792 provided in the second notification interface 702 and change their preference to be auto joined to this meeting, as reflected by the option now being switched “OFF”. Thus, it can be understood that throughout the various instances in a pre-meeting workflow, a user may continue to be presented with the option to auto-connect to the meeting, and may select or de-select the option as desired. Users can enjoy the flexibility and assurance that they can effortlessly change their mind at any point in which they view information for the meeting, and that they do not need to remember what connection mode they selected, as each meeting event instance will display the status of their auto-join selection.

In addition, the first notification interface 700 of FIG. 7A includes a first selectable auto-record option 794 that is turned “OFF” or deactivated. In some implementations, a user can decide not to auto join a meeting (as shown in FIG. 7B), and also activate or enable the auto-recording function for the meeting, via a second selectable auto-record option 796.

As noted above, in different implementations, the system may include provisions for adjusting, modifying, customizing, or otherwise specifying their preferred auto-connection settings. One example of this is illustrated in FIG. 8, where an implementation of a settings user interface 800 is shown. The settings user interface 900 includes a first portion labeled “General” 810, and a second portion labeled “Auto-Join Options” 820. In other implementations, alternative or additional functions and options may be provided for the user to configure, and the appearance of the user interface can vary widely from what is shown here, while still providing users the ability to personalize or ‘tweak’ the operation of the auto-connect feature, where these preferences may be applicable when the auto-connect feature is activated or enabled for a specific meeting. A few of these adjustable preferences will be described below with reference to FIG. 8.

As a first example, a user may be able to request that, going forward, the user should be auto-connected to all upcoming meetings (see selectable option 890). In other words, each meeting or event that is accepted by the user (e.g., an RSVP status of “yes”, or “maybe”) will be automatically updated as an auto-connect meeting for this user. While the illustration in FIG. 8 notes only the option of selecting “all upcoming meetings” for auto-connect, it should be understood that in other implementations, a user may be able to input a precise number of meetings that the feature should remain active (e.g., the next 3 meetings, the next 20 meetings, etc.), or that the feature should function until a specified date (e.g., meetings occurring until Mar. 14, 2025, meetings occurring until Dec. 4, 2030, etc.), or for a specified duration (e.g., meetings occurring over the 36 hours, meetings occurring over the next 2 weeks, meetings occurring over the next 4 months, etc.), or for specific team meetings (e.g., Marketing team meetings only, Financial team meetings and Budgeting team meetings, etc.), and/or for specific times or days (e.g., only meetings occurring between 11 am and 4 pm, only meetings occurring on Monday, only meetings occurring on a weekday, etc.). Through these options, a user can ensure their connection and attendance of meetings that matter most to them or that they might be required to attend.

In a second example, in some implementations, the system can be configured to receive input from a user specifying the time that they should be connected to the conference. In other words, the user interface may provide a means by which a user can input at what point in the meeting they wish to begin their telecommunications session. In FIG. 8, a first category 830 with a header 832 for a “What time would you like to be connected to the meeting?” is provided as an example. In first category 830, various sub-options are listed, including a first sub-option 834, a second sub-option 836, a third sub-option 838, and a fourth sub-option 840. A user can select the sub-option that best suits their preferences. Thus, if a user wishes to join a meeting at its scheduled start time, they may select the first sub-option 834. If the user wishes to be connected sometime prior to the meeting start time, they may select the second sub-option 836. While the second sub-option 836 of FIG. 8 presents only the opportunity of auto-connecting to the meeting 5 minutes before its scheduled start time, it should be understood that in other implementations, a user may also be able to input a precise number of minutes or other duration that the auto-connect should occur prior to the meeting.

In some cases, the user may wish to identify a condition that should occur before they are automatically joined to the meeting. In FIG. 8, the third sub-option 838 provides an opportunity for the user to specify the condition. This condition can vary, but can include for example, (a) a specified time after the entry or exit of one or more specific participant(s) to the conference, (b) when the number of participants attending the conference reaches a specified threshold (minimum), or other conditions that may be readily evaluated and determined by the system using the currently available meeting information. Finally, a fourth sub-option 840 can allow a user to specify the precise time at which they should be auto-connected to the meeting. Through these options, a user can be easily connected only to those meetings that match their specified criteria, or at the time that makes the most sense to them.

As a third example, in different implementations, the system can be configured to receive input from a user specifying the communication medium by which they should be connected to the conference (via telecommunications session). In other words, the user interface may provide a means by which a user can input which method the system should use when initiating the connection. In FIG. 8, a second category 850 with a header 832 for a “How should you be connected to the meeting?” is provided as an example. In second category 850, various sub-options are listed, including a first sub-option 852, a second sub-option 854, and a third sub-option 856. A user can select the sub-option that best suits their preferences. Thus, if a user wishes to auto join a meeting via a type of Voice over Internet Protocol (VoIP), they may select the first sub-option 852. This can be selected by the user by a list of suggested VoIP accounts, or manually entered. If the user instead wishes to be connected via a telephone (e.g., a landline, cellular phone, internet phone), they may select the second sub-option 854, and indicate which phone number should be called.

While the second category 850 of FIG. 8 offers only the opportunity to select a preferred auto-connect method, it should be understood that in other implementations, a user may also be able to indicate a plurality of connection methods, and an order in which each method should be used (represented generally by third sub-option 856 “Other”). In other words, in some implementations, the user interface may be configured to receive and store a list of the user's preferred contact points (PCPs), in the order that they wish the system to attempt connecting them, as well as how many times the system should attempt to reach the user at each PCP, how long to wait between each attempted connection, and/or at what frequency these attempts should occur for each PCP. Through these options, a user can ensure that the system reaches them at the appropriate PCP, while also allowing for several ‘back-up’ PCPs that reassure the user of the auto-connection, regardless of their physical location or what device they are currently proximate to.

In a fourth example, in some implementations, the system can be configured to receive input from a user specifying additional preferences associated with the auto-connection. In FIG. 8, a third category 860 is shown. In third category 860, various sub-options are listed, including a first sub-option 862, a second sub-option 864, and a third sub-option 866, and a fourth sub-option 868. A user can select one or more of the sub-options that best suit their preferences. Thus, in this example, if a user wishes to enable a snooze or ‘call-me-back’ functionality, they can select the first sub-option 862. The snooze duration can be specified (e.g., 30 seconds, 9 minutes, etc.) via second sub-option 864, or a default snooze duration (e.g., 1 minute, 5 minutes) may be applied by the system. This option can appear to them via the device they are using for receiving the call; for example, when the user answers the call, an automated voice may ask if the user wishes to activate snooze or join the call now, and the user can select their desired option at that time. Similarly, the user may receive an alert or message indicating the start of the call, and be able to select snooze at that time.

In other implementations, there are a variety of device configurations that are made available during a telecommunications session. For example, a user may wish to pre-specify that their camera be on (or off) at the start of the call (see third sub-option 866), and/or that their microphone be on (or off) at the start of the call (see fourth sub-option 868). While the third category 860 shown in FIG. 8 includes only four sub-options, in other implementations, the sub-options can vary and/or there may be additional sub-options. For example, a user may be able to indicate that any (or some specifically identified) meetings to which they are auto-connected should also be automatically recorded. Similarly, a user may be able to request that the system record any meeting for which they have confirmed their attendance when such meeting(s) conflicts or overlaps with a meeting that they will be auto-connecting to. In some implementations, the application can present another selectable option that allows a user to specify the automatic presentation of a deck (slides, screen share, etc.) for the meeting when the connection occurs.

Furthermore, in some cases, a user may be successfully auto-connected to a conference, but then unexpectedly or inadvertently lose their connection to the telecommunication session. For example, there may be issues with their internet connection, the device battery may be exhausted, the call may drop in areas with less coverage, or other such issues can often occur. In such situations, it is likely that the user will wish to be re-connected, and may not have ready or easy access to the conference calling information or required credentials. In order to address this type of scenario, the system can offer the user the option of automatically attempting to re-establish a connection between the user and the continuing telecommunications session. In some implementations, the user may be able to specify how many times the system should attempt to automatically re-connect them, how long to wait between attempts, and/or whether one or more different PCPs should be used. For example, the user may wish to have the system attempt connection with another PCP if the previous PCP is blocked or appears to be out of service. Thus, users can feel confident that they will be re-connected to meetings that are important to them, regardless of their current device status, signal strength, or physical location.

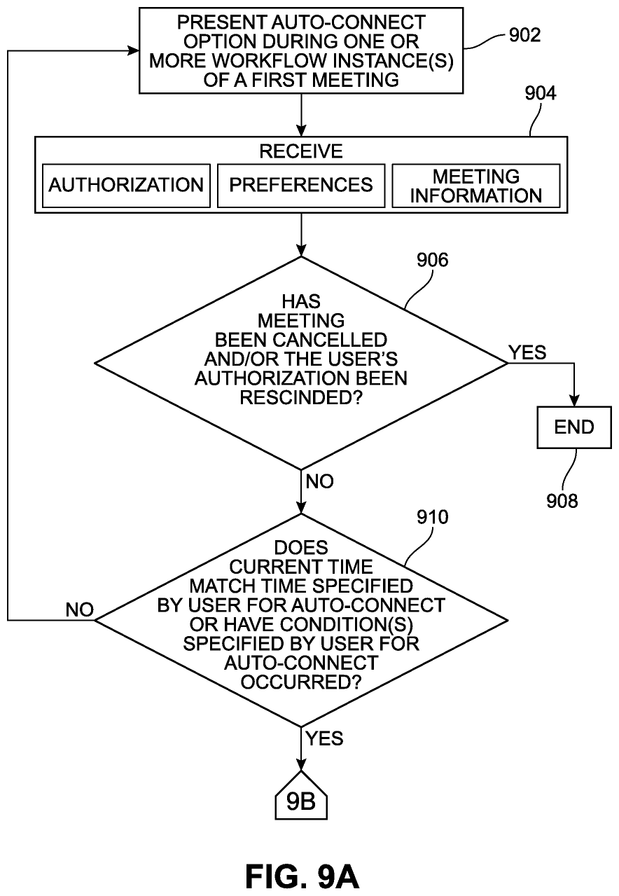

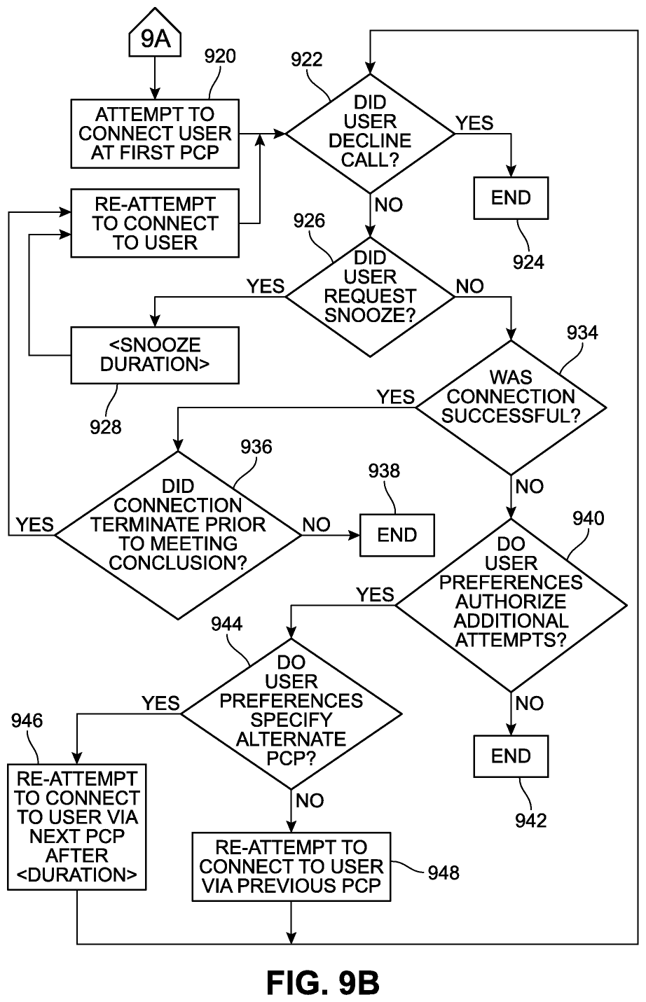

In order to further the reader's understanding of the proposed systems, a schematic flow diagram depicting one implementation of the system is illustrated in FIGS. 9A and 9B. As shown in FIG. 9A, in a first step 902, a conference system can be configured to present on a display of a user device an auto-connect option during one or more workflow instances for a first conference event. A user can submit their selection(s), where activation of the auto-connect option corresponds to a user authorization for the system to contact them at the specified time. This authorization, as well as any user preferences and the details of the meeting itself, can be received by the system in a second step 904. The system can ascertain if the authorization is still valid and current, as well as the status of the meeting, in a third step 906. If the meeting has been cancelled or the user has revoked their authorization for the auto-connection or declined the meeting invite, the system will not proceed with an attempt to automatically contact the user, as shown by a first terminus 908.

If, on the other hand, the meeting and authorization remain current, the system can determine, with reference to a calendar for example, whether the current time matches the time specified or otherwise designated by the user in a fourth step 910. If the auto-connect event is not to be triggered yet, the process can return to the start (first step 902) to continue receiving updated information for the first conference event. However, if the auto-connect is triggered, the flow diagram continues in FIG. 9B at a fifth step 920, where the system attempts to contact the user via the user's listed or preferred PCP.

In a sixth step 922 the system can determine whether the user opted to decline the call; if so, the system will no longer proceed with attempts to automatically contact the user, as shown by a second terminus 924. In a seventh step 926, the system evaluates whether any input has been received corresponding to a request for the snooze option. If the snooze option has been triggered, the system can delay for a pre-specified snooze duration in a ‘holding pattern’ step 928, after which the system will attempt to re-connect the user with the conference via initiation of a telecommunications session in an eighth step 932. If the snooze option has not been triggered, the system will ascertain whether the connection was successful in a ninth step 934. If the user has been successfully connected to the conference, the system will continue to monitor the connection. As noted above with respect to FIG. 8, there may be situations in which a user's connection to a meeting will be interrupted prior to the conclusion of the conference event. If the system detects or otherwise is able to determine that the connection has been interrupted (a tenth step 936), it will attempt to re-connect the user to the conference per user preferences, as represented by eighth step 932. If there is no interruption and the connection is maintained throughout the meeting, the system will essentially remain dormant, as shown by a third terminus 938.

Returning to the ninth step 934, if the connection attempt was unsuccessful, the system will ascertain whether the user preferences permit or authorize additional attempts in an eleventh step 940. If the user has directed that no additional attempts be made, the system will no longer proceed with attempts to automatically contact the user, as shown by a fourth terminus 942. If there is authorization—or a lack of prohibition—to reattempt connecting the user, the system can again access user preferences to determine whether the next attempt should be at the same PCP, or a different PCP, in a twelfth step 944. If the same PCP is designated for contact, the system again attempts to connect the user at the same PCP in a thirteenth step 948. If an alternate PCP is designated for contact, the next attempt will be to the alternate PCP in a fourteenth step 946. As noted above with respect to FIG. 8, these steps can be undertaken with reference to each of the user's preferences. The system can continue this process until a terminus step is reached or the call is concluded.

Through the application of such a system, users can be automatically brought into a meeting by establishing a telecommunications session with the user to the meeting. Users can identify their preferences for various aspects and steps leading to the connection, or the system can implement default settings. For example, in some implementations, a system first calls the user on their VoIP client. If the user cannot be reached at the VoIP client, the system then proceeds to attempt a connection on the user's phone line. When multiple users have opted to be auto-connected, they will all be brought into the meeting automatically by the system. In some implementations, users can also receive a notification in their email and/or a chat message stream if the system is unable to reach the user. The system can retry connecting the user, depending on the user settings. These settings can specify how and when the connection should occur, as well as device configurations such as audio and visual modes, auto presentation of a deck (slides) for the meeting, joining or inviting other participants, or choosing a room.

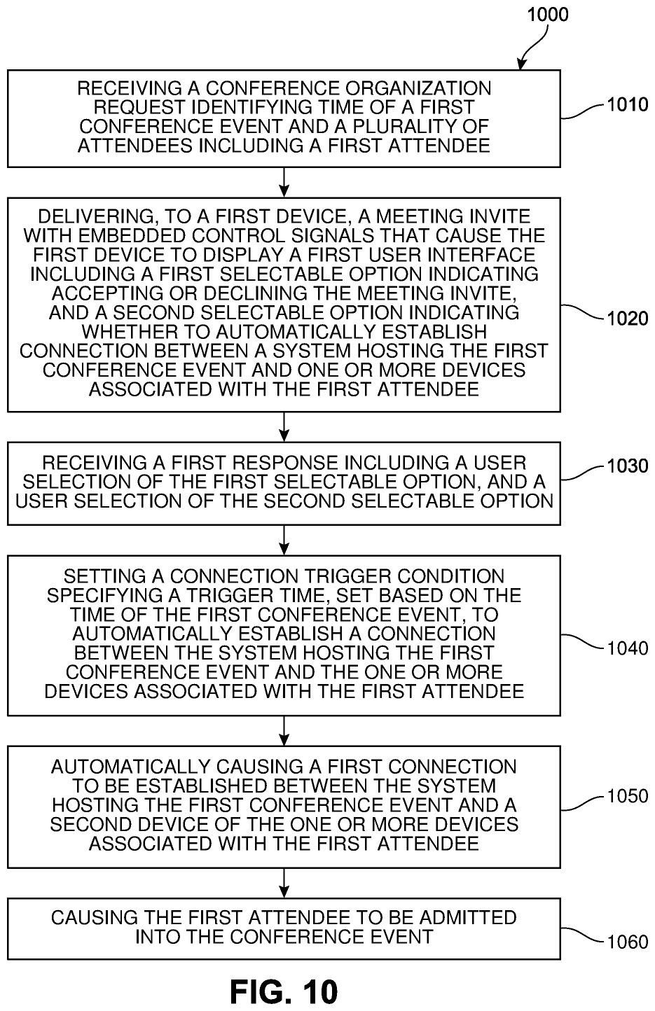

FIG. 10 is a flow chart illustrating an implementation of a method 1000 of managing the automatic connection of users to a conference event. In FIG. 10, a first step 1010 includes receiving a conference organization request identifying time of a first conference event and a plurality of attendees including a first attendee. A second step 1020 includes delivering, to a first device associated with the first attendee identified in the conference organization request, a meeting invite with embedded control signals. The embedded control signals, when executed by the first device, cause the first device to display a first user interface including the time of the first conference event, a first selectable option indicating accepting or declining the meeting invite, and a second selectable option indicating whether to automatically establish connection between a system hosting the first conference event and one or more devices associated with the first attendee.

A third step 1030 includes receiving, from the first device, a first response to the displayed first user interface. The first response includes a user selection of the first selectable option accepting the meeting invite, and a user selection of the second selectable option to automatically establish a connection between the system hosting the first conference event and the one or more devices associated with the first attendee. A fourth step 1040 involves setting a connection trigger condition corresponding to the first attendee and the first conference event. The connection trigger condition specifies a trigger time, set based on the time of the first conference event, to automatically establish a connection between the system hosting the first conference event and the one or more devices associated with the first attendee.

In a fifth step 1050, the method includes determining that the connection trigger condition has been met, automatically causing a first connection to be established between the system hosting the first conference event and a second device of the one or more devices associated with the first attendee. Finally in a sixth step 1060, the method includes causing the first attendee to be admitted into the first conference event.

In other implementations, the method can include additional or alternate steps. For example, the method may further include determining an interruption of the first connection between the first attendee and the first conference event has occurred prior to a conclusion of the first conference event, and then automatically causing, in response to determining that an interruption has occurred, a second connection with a third device of the one or more devices in order to re-connect the first attendee to the first conference event. In some implementations, the trigger time can correspond to a scheduled start time of the conference event, while in other implementations the trigger time can correspond to a pre-established time prior to a scheduled start time of the conference event. In one implementation, the first device and the second device can refer to the same device, and in another implementation the second device can differ from the first device.

As another example, the method may involve delivering, to the first device, an options interface with embedded control signals that, when executed by the first device, cause the first device to display a second user interface including a third selectable option indicating whether to automatically establish connections between one or more systems hosting one or more conference events and one or more devices associated with the first attendee for all future conference events occurring over a specified duration. The method can also include receiving, from the first device, a second response to the displayed second user interface, the second response including a user selection of the third selectable option, and setting an extended connection trigger condition corresponding to the first attendee and all conference events occurring over the specified duration. The method further includes automatically causing, in response to determining that a second conference event occurs during the specified duration, a second connection to be established between a system hosting the second conference event and a third device of the one or more devices associated with the first attendee.

In another example, the method can include causing a third device associated with a second attendee to display a second user interface including a third selectable option indicating whether to automatically establish connection between a system hosting a second conference event and one or more devices associated with the second attendee. Furthermore, the method may include receiving, from the third device, a second response to the displayed second user interface, the second response including a user selection of the third selectable option to automatically establish a connection between the system hosting the second conference event and the one or more devices associated with the second attendee. In addition, the method includes automatically initiating a second connection between the system hosting the second conference event and a fourth device of the one or more devices associated with the second attendee, and receiving, from the fourth device, a first input corresponding to a request to delay connection to the second conference event by a specified duration. The method can also include automatically causing, in response to determining that the specified duration has passed, a second connection to be established between the system hosting the second conference event and a fifth device of the one or more devices associated with the second attendee. In different implementations, the second user interface comprises a virtual invitation for the second conference event, a notification for the second conference event, an e-mail regarding the second conference event, or an instant message related to the second conference event.

Furthermore, in some implementations, the method may involve causing a third device associated with a second attendee to display a second user interface including a third selectable option indicating whether to automatically establish connection between a system hosting a second conference event and one or more devices associated with the second attendee. The method may also include receiving, from the third device, a second response to the displayed second user interface, the second response including a user selection of the third selectable option to automatically establish a connection between the system hosting the second conference event and the one or more devices associated with the second attendee. In addition, the method can involve automatically initiating a second connection between the system hosting the second conference event and a fourth device of the one or more devices associated with the second attendee, and determining the second attendee failed to connect to the second conference event via the fourth device. The method can further include automatically causing, in response to determining that the second attendee failed to connect to the second conference event, a third connection to be established between the system hosting the second conference event and a fifth device of the one or more devices associated with the second attendee.

As a general matter, an example system for management of conference calls can include a conference server (which in some implementations can include more than one server). The server can be located in multiple geographic areas. In addition, the conference server can be connected, often through a firewall, to a wide area network (WAN), such as the Internet. The WAN can be coupled to and accessed through either a wired connection or a wireless local area network (WLAN) that can feature a wireless access point that operates, for example, in accordance with one of the IEEE 802.11 specifications.

In some implementations, the conference server can also be connected to a public switched telephone network (PSTN) via direct inward dialing (DID) trunks or primary rate interface (PRI) trunks. The conference server can also communicate, often through a relay, with a public land mobile network (PLMN), which can also be referred to as a wireless wide area network (WWAN) or a cellular network. In some cases, the PLMN can be configured to be interconnected with or integrated into the PSTN.

In addition, the system can include a number of electronic devices, such as mobile devices and stationary devices. These can include for example, a cellular phone, a smartphone, a tablet, a netbook, a laptop, a PDA (personal digital assistant), or any other device enabled for wireless communication. A mobile device can be equipped for cellular communications through the PLMN, for communications over WAN (accessed, for example, through WLAN by connecting via Wi-Fi to wireless access points) or it can be a dual-mode device capable of both cellular and WAN/WLAN communications. Cellular communications through the PLMN can include voice communications and data communications, and mobile device can support either or both these communication channels.

A mobile device can also include one or more radio transceivers and associated processing hardware and software to enable wireless communications with PLMN, and/or a WLAN via a wireless access point. In different implementations, the PLMN and a mobile device may be configured to operate in compliance with any one or more of a number of wireless protocols, including GSM, GPRS, CDMA, EDGE, UMTS, EvDO, HSPA, 3GPP, LTE, or a variety of others. In addition, a mobile device can roam within PLMN and across PLMNs, in a known manner, as its user moves. In some instances, a dual-mode mobile device and/or the conference server may be configured to facilitate roaming between PLMN and wireless access points, and are thus capable of seamlessly transferring sessions (such as voice calls) from a connection with the cellular interface of a dual-mode device (i.e., mobile device) to a WLAN interface of the dual-mode device, and vice versa.

There may also be a relay that serves to direct communications received over PLMN from a device to the conference server. The relay can also direct communications from the conference server to the mobile device via PLMN. Furthermore, in another implementation, a telephone set (such as a conventional landline telephone) can communicate with the conference server through PSTN.

In different implementations, the conference server can be implemented on one or more servers having suitable communications interfaces for connecting to and communicating with other system components. The conference server can include one or more processors, a memory, and a data interface. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory.

In some implementations, a memory stores user-profile or account information and user preferences for one or more users. The user-profile information can include, for example, a user's name, email address, location data, place of employment, home address, or the like. In addition, the user-profile information can include device information for one or more electronic devices (e.g., one or more mobile or computing devices and/or one or more telephone sets) associated with a user. Device information can include device's phone number (e.g., a cellular phone number or a landline number), a personal identification number (PIN), an IP address, if available, and so forth. In some embodiments, some or all of the user-profile information, including device information, can be retrieved, by the conference server, from the electronic devices. For example, if user-information for a particular electronic device includes device information only for one device associated with the user, and the device information includes only the IP address of the device, the conference server can use the IP information to communicate with the electronic device, for example, via WAN. The conference server can then retrieve from the electronic device additional device information for the device itself (e.g., a cellphone number associated with the device) and/or device information for other electronic devices associated with the same user (e.g., a landline number of the user's telephone set).

In one implementation, the conference server implements the switching to connect session legs and provides the conversion between, for example, a circuit-switched call and a VoIP call, or to connect legs of other media sessions. In some embodiments, in the context of voice calls, the conference server provides a number of additional functions including an automated attendant, interactive voice responses, call forwarding, conference call, or other such features. It can also implement certain usage restrictions on enterprise users, such as blocking international calls or toll free calls. In many embodiments, Session Initiation Protocol (SIP) can be used to set-up, manage, and terminate media sessions for voice calls. Other protocols can also be employed by the conference server, such as Web Services, Computer Telephony Integration (CTI) protocol, Session Initiation Protocol for Instant Messaging and Presence Leveraging Extensions (SIMPLE), and various custom Application Programming Interfaces (APIs).

The use of the disclosed systems and methods can enable users to review information for a conference at multiple points prior to the meeting time, and be presented an option to be auto joined to said conference during this review. In other words, in conjunction with their viewing of information for said conference, a user can readily opt to be automatically connected to the conference at a time specified for the conference. For example, as a user creates a meeting and its corresponding invitation, while a user views an invitation for the meeting, when a user RSVPs (or changes their RSVP) for the meeting, during any meeting notifications, meeting indicators, meeting “toasts” or pop-up messages, e-mail communications from the system or other users about the meeting, meeting preparation communications, or meeting objects can provide instances in which a user can be presented with an option to auto-join the meeting, making the process highly convenient and relevant. The ability to deliberately select this option for individual meetings at a time of their choosing, offers a wide range of benefits to users. This feature substantially reduces the time needed to prepare for user participation in the meeting, and the aggravation of being auto-joined to all meetings because of a setting that was modified previously for another meeting or forgetting to change one's general settings to auto-join scan various items. Furthermore, users are offered a straightforward means by which to implement their preferences for participating in a meeting, and the ability to easily change one's mind about the means of connecting to the meeting at multiple opportunities leading up to the meeting.

For the sake of simplicity of description, details are not provided herein for performing various connection processes and the configuration of different telecommunication components. Implementations of the present disclosure can make use of any of the features, systems, components, devices, and methods described in U.S. Patent Publication Number 2009/0319916 to Gudipaty et al., published Dec. 24, 2009 and entitled “Techniques to auto-attend multimedia conference events,”; U.S. Patent Publication Number 2012/0275349 to Boyer et al., published Nov. 1, 2012 and entitled “Conference call monitoring with automatic reconnect”; U.S. Patent Publication Number 2017/0302718 to Ananthanarayanan et al., published Oct. 19, 2017 and entitled “Dynamic recording of online conference”; U.S. Patent Publication Number 2013/0144603 to Lord et al., published Jun. 6, 2013 and entitled “Enhanced voice conferencing with history”; U.S. Patent Publication Number 2011/0267419 to Quinn et al., published Nov. 3, 2011 and entitled “Accelerated instant replay for co-present and distributed meetings”; U.S. Patent Publication Number 2011/0249954 to Meek et al., published Oct. 13, 2011 and entitled “Capturing presentations in online conferences”; U.S. Patent Publication Number 2014/0362979 to Kaplan et al., published Dec. 11, 2014 and entitled “Catching up with an ongoing conference call”; U.S. Patent Publication Number 2010/0246448 to Krantz et al., published Sep. 30, 2010 and entitled “Automatic utilization of resources in a realtime conference”; U.S. Patent Publication Number 20120297229 to Desai et al., published on Nov. 22, 2012 and entitled “Auto-connect in a peer-to-peer network”; and U.S. Patent Publication Number 2016/0373490 to Sedar et al., published on Dec. 22, 2016 and entitled “Automatic equipment configuration for meetings” as well as each of their disclosed methods and systems for the management of meetings, connection to and recording of conferences, and so forth, the disclosures of each of which are herein incorporated by reference in their entirety.

The detailed examples of systems, devices, and techniques described in connection with FIGS. 1-10 are presented herein for illustration of the disclosure and its benefits. Such examples of use should not be construed to be limitations on the logical process implementations of the disclosure, nor should variations of user interface methods from those described herein be considered outside the scope of the present disclosure. In some implementations, various features described in FIGS. 1-10 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations, and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a particular processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In implementations in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across a number of machines. Processors or processor-implemented modules may be located in a single geographic location (for example, within a home or office environment, or a server farm), or may be distributed across multiple geographic locations.

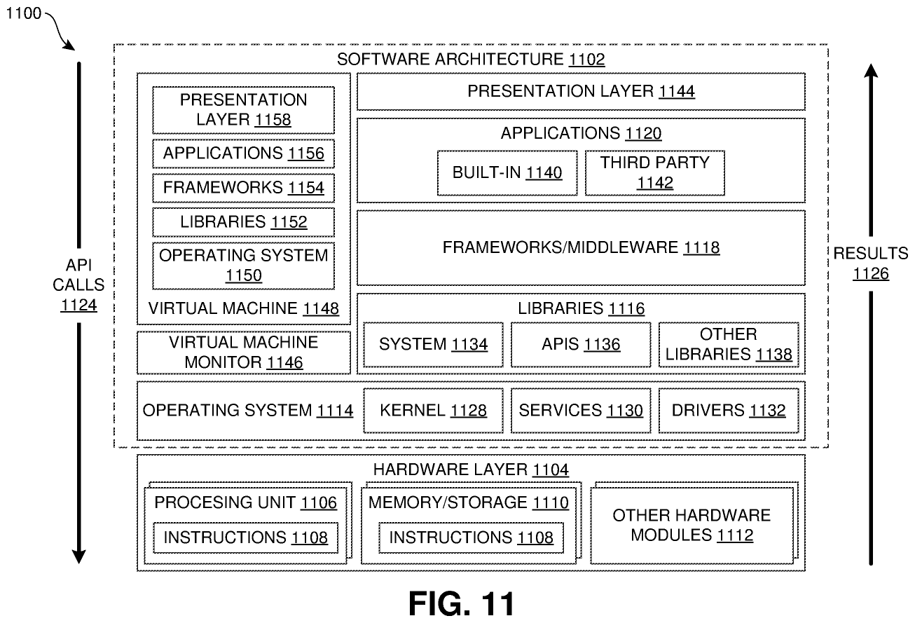

FIG. 11 is a block diagram 1100 illustrating an example software architecture 1102, various portions of which may be used in conjunction with various hardware architectures herein described, which may implement any of the above-described features. FIG. 11 is a non-limiting example of a software architecture and it will be appreciated that many other architectures may be implemented to facilitate the functionality described herein. The software architecture 1102 may execute on hardware such as a device 120 of FIG. 1 that includes, among other things, document storage 1070, processors, memory, and input/output (I/O) components. A representative hardware layer 1104 is illustrated and can represent, for example, the device 120 of FIG. 1. The representative hardware layer 1104 includes a processing unit 1106 and associated executable instructions 1108. The executable instructions 1108 represent executable instructions of the software architecture 1102, including implementation of the methods, modules and so forth described herein. The hardware layer 1104 also includes a memory/storage 1110, which also includes the executable instructions 1108 and accompanying data. The hardware layer 1104 may also include other hardware modules 1112. Instructions 1108 held by processing unit 1108 may be portions of instructions 1108 held by the memory/storage 1110.

The example software architecture 1102 may be conceptualized as layers, each providing various functionality. For example, the software architecture 1102 may include layers and components such as an operating system (OS) 1114, libraries 1116, frameworks 1118, applications 1120, and a presentation layer 1144. Operationally, the applications 1120 and/or other components within the layers may invoke API calls 1124 to other layers and receive corresponding results 1126. The layers illustrated are representative in nature and other software architectures may include additional or different layers. For example, some mobile or special purpose operating systems may not provide the frameworks/middleware 1118.

The OS 1114 may manage hardware resources and provide common services. The OS 1114 may include, for example, a kernel 1128, services 1130, and drivers 1132. The kernel 1128 may act as an abstraction layer between the hardware layer 1104 and other software layers. For example, the kernel 1128 may be responsible for memory management, processor management (for example, scheduling), component management, networking, security settings, and so on. The services 1130 may provide other common services for the other software layers. The drivers 1132 may be responsible for controlling or interfacing with the underlying hardware layer 1104. For instance, the drivers 1132 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1116 may provide a common infrastructure that may be used by the applications 1120 and/or other components and/or layers. The libraries 1116 typically provide functionality for use by other software modules to perform tasks, rather than rather than interacting directly with the OS 1114. The libraries 1116 may include system libraries 1134 (for example, C standard library) that may provide functions such as memory allocation, string manipulation, file operations. In addition, the libraries 1116 may include API libraries 1136 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1116 may also include a wide variety of other libraries 1138 to provide many functions for applications 1120 and other software modules.

The frameworks 1118 (also sometimes referred to as middleware) provide a higher-level common infrastructure that may be used by the applications 1120 and/or other software modules. For example, the frameworks 1118 may provide various graphic user interface (GUI) functions, high-level resource management, or high-level location services. The frameworks 1118 may provide a broad spectrum of other APIs for applications 1120 and/or other software modules.

The applications 1120 include built-in applications 1140 and/or third-party applications 1142. Examples of built-in applications 1140 may include, but are not limited to, a contacts application, a browser application, a location application, a media application, a messaging application, and/or a game application. Third-party applications 1142 may include any applications developed by an entity other than the vendor of the particular platform. The applications 1120 may use functions available via OS 1114, libraries 1116, frameworks 1118, and presentation layer 1144 to create user interfaces to interact with users.

Some software architectures use virtual machines, as illustrated by a virtual machine 1148. The virtual machine 1148 provides an execution environment where applications/modules can execute as if they were executing on a hardware machine (such as the machine 1000 of FIG. 10, for example). The virtual machine 1148 may be hosted by a host OS (for example, OS 1114) or hypervisor, and may have a virtual machine monitor 1146 which manages operation of the virtual machine 1148 and interoperation with the host operating system. A software architecture, which may be different from software architecture 1102 outside of the virtual machine, executes within the virtual machine 1148 such as an OS 1150, libraries 1152, frameworks 1154, applications 1156, and/or a presentation layer 1158.

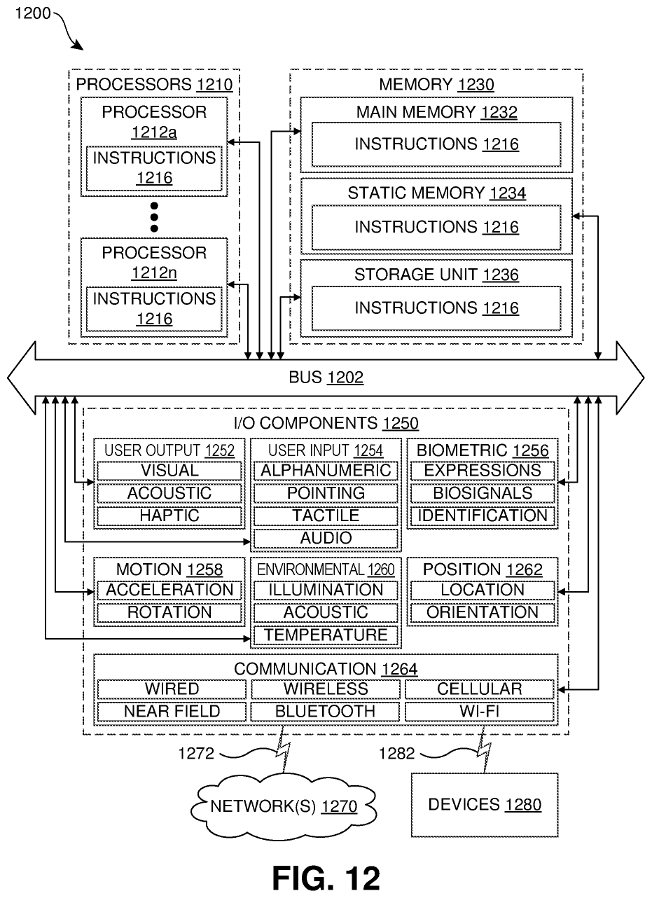

FIG. 12 is a block diagram illustrating components of an example machine 1200 configured to read instructions from a machine-readable medium (for example, a machine-readable storage medium) and perform any of the features described herein. The example machine 1200 is in a form of a computer system, within which instructions 1216 (for example, in the form of software components) for causing the machine 1200 to perform any of the features described herein may be executed. As such, the instructions 1216 may be used to implement modules or components described herein. The instructions 1216 cause unprogrammed and/or unconfigured machine 1200 to operate as a particular machine configured to carry out the described features. The machine 1200 may be configured to operate as a standalone device or may be coupled (for example, networked) to other machines. In a networked deployment, the machine 1200 may operate in the capacity of a server machine or a client machine in a server-client network environment, or as a node in a peer-to-peer or distributed network environment. Machine 1200 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1200 is illustrated, the term “machine” include a collection of machines that individually or jointly execute the instructions 1216.

The machine 1200 may include processors 1210, memory 1230, and I/O components 1250, which may be communicatively coupled via, for example, a bus 1202. The bus 1202 may include multiple buses coupling various elements of machine 1200 via various bus technologies and protocols. In an example, the processors 1210 (including, for example, a central processing unit (CPU), a graphics processing unit (GPU), a digital signal processor (DSP), an ASIC, or a suitable combination thereof) may include one or more processors 1212a to 1212n that may execute the instructions 1216 and process data. In some examples, one or more processors 1210 may execute instructions provided or identified by one or more other processors 1210. The term “processor” includes a multi-core processor including cores that may execute instructions contemporaneously. Although FIG. 12 shows multiple processors, the machine 1200 may include a single processor with a single core, a single processor with multiple cores (for example, a multi-core processor), multiple processors each with a single core, multiple processors each with multiple cores, or any combination thereof. In some examples, the machine 1200 may include multiple processors distributed among multiple machines.

The memory/storage 1230 may include a main memory 1232, a static memory 1234, or other memory, and a storage unit 1236, both accessible to the processors 1210 such as via the bus 1202. The storage unit 1236 and memory 1232, 1234 store instructions 1216 embodying any one or more of the functions described herein. The memory/storage 1230 may also store temporary, intermediate, and/or long-term data for processors 1210. The instructions 1216 may also reside, completely or partially, within the memory 1232, 1234, within the storage unit 1236, within at least one of the processors 1210 (for example, within a command buffer or cache memory), within memory at least one of I/O components 1250, or any suitable combination thereof, during execution thereof. Accordingly, the memory 1232, 1234, the storage unit 1236, memory in processors 1210, and memory in I/O components 1250 are examples of machine-readable media.

As used herein, “machine-readable medium” refers to a device able to temporarily or permanently store instructions and data that cause machine 1200 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 1216) for execution by a machine 1200 such that the instructions, when executed by one or more processors 1210 of the machine 1200, cause the machine 1200 to perform and one or more of the features described herein. Accordingly, a “machine-readable medium” may refer to a single storage device, as well as “cloud-based” storage systems or storage networks that include multiple storage apparatus or devices.

The I/O components 1250 may include a wide variety of hardware components adapted to receive input, provide output, produce output, transmit information, exchange information, capture measurements, and so on. The specific I/O components 1250 included in a particular machine will depend on the type and/or function of the machine. For example, mobile devices such as mobile phones may include a touch input device, whereas a headless server or IoT device may not include such a touch input device. The particular examples of I/O components illustrated in FIG. 12 are in no way limiting, and other types of components may be included in machine 1200. The grouping of I/O components 1250 are merely for simplifying this discussion, and the grouping is in no way limiting. In various examples, the I/O components 1250 may include user output components 1252 and user input components 1254. User output components 1252 may include, for example, display components for displaying information (for example, a liquid crystal display (LCD) or a projector), acoustic components (for example, speakers), haptic components (for example, a vibratory motor or force-feedback device), and/or other signal generators. User input components 1254 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1250 may include biometric components 1256 and/or position components 1262, among a wide array of other environmental sensor components. The biometric components 1256 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 1262 may include, for example, location sensors (for example, a Global Position System (GPS) receiver), altitude sensors (for example, an air pressure sensor from which altitude may be derived), and/or orientation sensors (for example, magnetometers).

The I/O components 1250 may include communication components 1264, implementing a wide variety of technologies operable to couple the machine 1200 to network(s) 1270 and/or device(s) 1280 via respective communicative couplings 1272 and 1282. The communication components 1264 may include one or more network interface components or other suitable devices to interface with the network(s) 1270. The communication components 1264 may include, for example, components adapted to provide wired communication, wireless communication, cellular communication, Near Field Communication (NFC), Bluetooth communication, Wi-Fi, and/or communication via other modalities. The device(s) 1280 may include other machines or various peripheral devices (for example, coupled via USB).

In some examples, the communication components 1264 may detect identifiers or include components adapted to detect identifiers. For example, the communication components 1264 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1262, such as, but not limited to, geo-location via Internet Protocol (IP) address, location via Wi-Fi, cellular, NFC, Bluetooth, or other wireless station identification and/or signal triangulation.

Furthermore, implementations of the present disclosure can make use of any of the features, systems, components, devices, and methods described in U.S. Pat. No. 8,660,978 to Hinckley et al., issued Feb. 25, 2014 and titled “Detecting and Responding to Unintentional Contact with a Computing Device,” the disclosure of which is herein incorporated by reference in its entirety.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

What is claimed is:

1. A system comprising:
at least one processor; and
one or more computer readable media including instructions which, when executed by the at least one processor, cause the at least one processor to:
receive a conference organization request identifying time of a first conference event and a plurality of attendees including a first attendee;
deliver, to a first device associated with the first attendee identified in the conference organization request, a meeting invite with embedded control signals that, when executed by the first device, cause the first device to display a first user interface including the time of the first conference event, a first selectable option indicating accepting or declining the meeting invite, and a second selectable option indicating whether to automatically establish connection between a system hosting the first conference event and one or more devices associated with the first attendee;
receive, from the first device, a first response to the displayed first user interface, the first response including a user selection of the first selectable option accepting the meeting invite, and a user selection of the second selectable option to automatically establish a connection between the system hosting the first conference event and the one or more devices associated with the first attendee;
set a connection trigger condition corresponding to the first attendee and the first conference event, the connection trigger condition specifying a trigger time, set based on the time of the first conference event, to automatically establish a connection between the system hosting the first conference event and the one or more devices associated with the first attendee;
in response to determining that the connection trigger condition has been met, automatically cause a first connection to be established between the system hosting the first conference event and a second device of the one or more devices associated with the first attendee; and
cause the first attendee to be admitted into the first conference event.

2. The system of claim 1, wherein the instructions further cause the at least one processor to:
determine an interruption of the first connection between the first attendee and the first conference event has occurred prior to a conclusion of the first conference event; and
automatically cause, in response to determining that an interruption has occurred, a second connection with a third device of the one or more devices in order to re-connect the first attendee to the first conference event.

3. The system of claim 1, wherein the trigger time corresponds to a scheduled start time of the conference event.

4. The system of claim 1, wherein the trigger time corresponds to a pre-established time prior to a scheduled start time of the conference event.

5. The system of claim 1, wherein the first device and the second device refer to the same device.

6. The system of claim 1, wherein the second device differs from the first device.

7. The system of claim 1, wherein the instructions further cause the at least one processor to:
deliver, to the first device, an options interface with embedded control signals that, when executed by the first device, cause the first device to display a second user interface including a third selectable option indicating whether to automatically establish connections between one or more systems hosting one or more conference events and one or more devices associated with the first attendee for all future conference events occurring over a specified duration;
receive, from the first device, a second response to the displayed second user interface, the second response including a user selection of the third selectable option;
set an extended connection trigger condition corresponding to the first attendee and all conference events occurring over the specified duration; and
automatically cause, in response to determining that a second conference event occurs during the specified duration, a second connection to be established between a system hosting the second conference event and a third device of the one or more devices associated with the first attendee.

8. The system of claim 1, wherein the instructions further cause the at least one processor to:
cause a third device associated with a second attendee to display a second user interface including a third selectable option indicating whether to automatically establish connection between a system hosting a second conference event and one or more devices associated with the second attendee;
receive, from the third device, a second response to the displayed second user interface, the second response including a user selection of the third selectable option to automatically establish a connection between the system hosting the second conference event and the one or more devices associated with the second attendee;
automatically initiate a second connection between the system hosting the second conference event and a fourth device of the one or more devices associated with the second attendee;
receive, from the fourth device, a first input corresponding to a request to delay connection to the second conference event by a specified duration; and
automatically cause, in response to determining that the specified duration has passed, a second connection to be established between the system hosting the second conference event and a fifth device of the one or more devices associated with the second attendee.

9. The system of claim 8, wherein the second user interface comprises a virtual invitation for the second conference event, a notification for the second conference event, an e-mail regarding the second conference event, or an instant message related to the second conference event.

10. The system of claim 1, wherein the instructions further cause the at least one processor to:
cause a third device associated with a second attendee to display a second user interface including a third selectable option indicating whether to automatically establish connection between a system hosting a second conference event and one or more devices associated with the second attendee;
receive, from the third device, a second response to the displayed second user interface, the second response including a user selection of the third selectable option to automatically establish a connection between the system hosting the second conference event and the one or more devices associated with the second attendee;
automatically initiate a second connection between the system hosting the second conference event and a fourth device of the one or more devices associated with the second attendee;
determine the second attendee failed to connect to the second conference event via the fourth device; and
automatically cause, in response to determining that the second attendee failed to connect to the second conference event, a third connection to be established between the system hosting the second conference event and a fifth device of the one or more devices associated with the second attendee.

11. A method performed by a data processing system comprising:
receiving a conference organization request identifying time of a first conference event and a plurality of attendees including a first attendee;
delivering, to a first device associated with the first attendee identified in the conference organization request, a meeting invite with embedded control signals that, when executed by the first device, cause the first device to display a first user interface including the time of the first conference event, a first selectable option indicating accepting or declining the meeting invite, and a second selectable option indicating whether to automatically establish connection between a system hosting the first conference event and one or more devices associated with the first attendee;
receiving, from the first device, a first response to the displayed first user interface, the first response including a user selection of the first selectable option accepting the meeting invite, and a user selection of the second selectable option to automatically establish a connection between the system hosting the first conference event and the one or more devices associated with the first attendee;
setting a connection trigger condition corresponding to the first attendee and the first conference event, the connection trigger condition specifying a trigger time, set based on the time of the first conference event, to automatically establish a connection between the system hosting the first conference event and the one or more devices associated with the first attendee;
in response to determining that the connection trigger condition has been met, automatically causing a first connection to be established between the system hosting the first conference event and a second device of the one or more devices associated with the first attendee; and
causing the first attendee to be admitted into the first conference event.

12. The method of claim 11, further comprising:
determining an interruption of the first connection between the first attendee and the first conference event has occurred prior to a conclusion of the first conference event; and
automatically causing, in response to determining that an interruption has occurred, a second connection with a third device of the one or more devices in order to re-connect the first attendee to the first conference event.

13. The method of claim 11, further comprising:
delivering, to the first device, an options interface with embedded control signals that, when executed by the first device, cause the first device to display a second user interface including a third selectable option indicating whether to automatically establish connections between one or more systems hosting one or more conference events and one or more devices associated with the first attendee for all future conference events occurring over a specified duration;
receiving, from the first device, a second response to the displayed second user interface, the second response including a user selection of the third selectable option;
setting an extended connection trigger condition corresponding to the first attendee and all conference events occurring over the specified duration; and
automatically causing, in response to determining that a second conference event occurs during the specified duration, a second connection to be established between a system hosting the second conference event and a third device of the one or more devices associated with the first attendee.

14. The method of claim 11, further comprising:
causing a third device associated with a second attendee to display a second user interface including a third selectable option indicating whether to automatically establish connection between a system hosting a second conference event and one or more devices associated with the second attendee;
receiving, from the third device, a second response to the displayed second user interface, the second response including a user selection of the third selectable option to automatically establish a connection between the system hosting the second conference event and the one or more devices associated with the second attendee;
automatically initiating a second connection between the system hosting the second conference event and a fourth device of the one or more devices associated with the second attendee;
receiving, from the fourth device, a first input corresponding to a request to delay connection to the second conference event by a specified duration; and
automatically causing, in response to determining that the specified duration has passed, a second connection to be established between the system hosting the second conference event and a fifth device of the one or more devices associated with the second attendee.

15. The method of claim 14, wherein the second user interface comprises a virtual invitation for the second conference event, a notification for the second conference event, an e-mail regarding the second conference event, or an instant message related to the second conference event.

16. The method of claim 11, further comprising:
causing a third device associated with a second attendee to display a second user interface including a third selectable option indicating whether to automatically establish connection between a system hosting a second conference event and one or more devices associated with the second attendee;
receiving, from the third device, a second response to the displayed second user interface, the second response including a user selection of the third selectable option to automatically establish a connection between the system hosting the second conference event and the one or more devices associated with the second attendee;
automatically initiating a second connection between the system hosting the second conference event and a fourth device of the one or more devices associated with the second attendee;
determining the second attendee failed to connect to the second conference event via the fourth device; and
automatically causing, in response to determining that the second attendee failed to connect to the second conference event, a third connection to be established between the system hosting the second conference event and a fifth device of the one or more devices associated with the second attendee.

17. The method of claim 11, wherein:
the first user interface further includes a third selectable option indicating whether to automatically record the first conference event; and
the method further comprises:
receiving, from the first device, a second response to the displayed first user interface, the second response including a user selection of the third selectable option to automatically record the first conference event, and
automatically initiating, in response to the user selection of the third selectable option, a recording of the first conference event at the trigger time.

18. The method of claim 11, wherein the trigger time corresponds to a pre-established time prior to a scheduled start time of the conference event.

19. A system comprising:
means for receiving a conference organization request identifying time of a first conference event and a plurality of attendees including a first attendee;
means for delivering, to a first device associated with the first attendee identified in the conference organization request, a meeting invite with embedded control signals that, when executed by the first device, cause the first device to display a first user interface means including the time of the first conference event, a first selectable option indicating accepting or declining the meeting invite, and a second selectable option indicating whether to automatically establish connection between a means for hosting the first conference event and one or more devices associated with the first attendee;
means for receiving, from the first device, a first response to the displayed first user interface means, the first response including a user selection of the first selectable option accepting the meeting invite, and a user selection of the second selectable option to automatically establish a connection between the means for hosting the first conference event and the one or more devices associated with the first attendee;
means for setting a connection trigger condition corresponding to the first attendee and the first conference event, the connection trigger condition specifying a trigger time, set based on the time of the first conference event, to automatically establish a connection between the means for hosting the first conference event and the one or more devices associated with the first attendee;
means for automatically causing, in response to determining that the connection trigger condition has been met, a first connection to be established between the means for hosting the first conference event and a second device of the one or more devices associated with the first attendee; and
means for causing the first attendee to be admitted into the first conference event.

20. The system of claim 19, further comprising:
means for determining an interruption of the first connection between the first attendee and the first conference event has occurred prior to a conclusion of the first conference event; and
means for automatically causing, in response to determining that an interruption has occurred, a second connection with a third device of the one or more devices in order to re-connect the first attendee to the first conference event.
